(19) United States
(12) Patent Application Publication
(10) Pub. No.: US 2025/0159616 A1
(43) Pub. Date: May 15, 2025

(54) CELL TRANSMIT POWER CHANGE IN WIRELESS COMMUNICATION NETWORKS

(71) Applicant: Nokia Technologies Oy, Espoo (FI)

(72) Inventors: Mads LAURIDSEN, Gistrup (DK); Jeroen WIGARD, Klarup (DK); Daniela LASELVA, Klarup (DK)

(21) Appl. No.: 18/838,273

(22) PCT Filed: Dec. 16, 2022
(86) PCT No.: PCT/FI2022/050844

§ 371 Date: Aug. 14, 2024

(30) Foreign Application Priority Data
Feb. 14, 2022 (FI) 20225130

(51) Int. Cl. H04W 52/24; H04B 7/185; H04B 17/318; H04W 52/40

(52) U.S. Cl. CPC H04W 52/245; H04B 7/18543; H04B 17/328; H04W 52/40

(57) ABSTRACT

Various example embodiments relate to a solution for network communication. A network device may be configured to cause transmission of cell operation mode configuration parameters to be applied in a cell operation mode; and cause transmission of a cell operation mode indication associated with at least one cell of a network, the cell operation mode indication initiating a cell transmission power change sequence.

### TECHNICAL FIELD

Various example embodiments generally relate to the field of wireless data communications. In particular, some example embodiments relate to a solution for changing cell transmit power in wireless communication networks.

### BACKGROUND

Non-terrestrial networks comprise networks that may use an airborne or spaceborne platform as a part of the network, such as satellites, high-altitude platforms or drones. Satellites can be classified in terms of their altitude, from low-Earth orbit (LEO) to geostationary Earth orbit (GEO) satellites. LEO satellites are deployed in large constellations and move with respect to the Earth's surface with a speed of approximately 7.5 km/s to maintain their orbit. As the LEO satellites move with respect to the Earth, this may lead to frequent handovers, even if a user equipment (UE) served by the LEO satellites is not moving.

The LEO satellites may be capable of beam-steering such that a beam (and thus a New Radio (NR) cell) is projected towards a fixed location on Earth for some time. These cells may be called as (quasi) Earth-fixed cells (EFC). The use of EFCs may reduce the number of mobility events experienced by UEs as compared to LEO satellites without beam-steering where cells will be moving on earth in correspondence with satellite movement.

However, an EFC will eventually be subject to a change of a satellite, because the previous satellite moves too far away from the fixed location of a user equipment on Earth. Depending on satellite constellation and capability this happens more or less frequently, but the fast satellite movement (about 7.5 km/s for 600 km altitude) means it is in the order of minutes for typical scenarios.

When the satellite switch takes place, the network operator can either switch the beam of the current satellite away and then switch in the new beam, or first switch the new beam into the area and then switch the beam of the current satellite away. The latter approach facilitates service continuity, where the UE is able to perform a measurement to the new beam and a handover (or cell reselection for Idle/Inactive UEs) to such new beam.

One possible solution for enabling a smooth change of a UE from a current cell to a new cell is to reduce the transmit power levels of the current serving cell so that UE measurements will indicate the target cell has better radio conditions. The UE may measure the reference signal received power (RSRP) of cells based on the secondary synchronization signal (SSS), which is contained in the synchronization signal and PBCH Block (SSB). Connected UEs may also base their RSRP measurements on channel state information Reference Signals (CSI-RS).

Irrespective of the signal measured, the power level of either signal is linked to the SS-PBCH-BlockPower parameter, which is provided as part of the System Information Broadcast 1 (SIB1). This means that the change of the power level transmitted by a cell is subject to providing a system information (SI) change indication to the UEs. This means that the network has to inform the UE in one modification period that the system information will change in the next modification period. As an example, the modification period may be [2 4 8 16]*default paging cycle (in radio frames), where the default paging cycle can be set out of [320 640 1280 2560] ms. A typical paging cycle may be 1280 ms, which means the cell power level cannot be changed more frequently than every 2*1.280 s˜2.5 s.

Considering that the time that two cells overlap in an EFC should be as short as possible to reduce the interference, it is problematic that the speed at which the cell power reduction can be enforced is limited by the relatively long duration of the modification period.

Furthermore, the SI information change caused by the change of the power level transmitted by a cell, will cause all UEs in the cell, both Idle, Inactive and Connected to read the updated SIB(s) for each step in which the power level of SS-PBCH-BlockPower is reduced, and thus the UE energy consumption will increase. This increase in energy consumption may be especially relatively large for IoT devices with low data cycles.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution that allows a network to inform UEs that a cell is in a cell operation mode and the cell transmit power is being reduced or increased, without requiring a system information (SI) change indication. This benefit may be achieved by the features of the independent claims. Further implementation forms are provided in the dependent claims, the description, and the drawings.

According to a first aspect, a network device may comprise at least one processor and at least one memory including computer program code. The at least one memory and the computer program code are configured to, with the at least one processor, cause the network device at least to: cause transmission of cell operation mode configuration parameters to be applied in a cell operation mode, and cause transmission of a cell operation mode indication associated with at least one cell of a network, the cell operation mode initiating a cell transmission power change sequence.

In an implementation form of the first aspect, the cell operation mode configuration parameters comprise at least one of a cell transmission power scaling parameter, time duration parameter, or start or end time parameter.

In an implementation form of the first aspect, the start or end time parameter is associated with an absolute subframe number or the default paging cycle, or a synchronization signal PBCH and block, SSB, periodicity or any other network-controlled period.

In an implementation form of the first aspect, the at least one memory and the computer program code are configured to, with the at least one processor, cause the network device at least to change the cell transmission power based on the cell operation mode configuration parameters.

In an implementation form of the first aspect, the at least one memory and the computer program code are configured to, with the at least one processor, cause the network device at least to cause transmission of the cell operation mode configuration parameters in system information broadcast signaling.

In an implementation form of the first aspect, the at least one memory and the computer program code are configured to, with the at least one processor, cause the network device at least to cause transmission of the cell operation mode configuration parameters in radio resource control signaling.

In an implementation form of the first aspect, the at least one memory and the computer program code are configured to, with the at least one processor, cause the network device at least to prevent triggering of a system information change indication when changing a level of the cell transmission power, when the cell operation mode is enabled.

In an implementation form of the first aspect, the at least one memory and the computer program code are configured to, with the at least one processor, cause the network device at least to cause transmission of the cell operation mode indication in system information broadcast signaling.

In an implementation form of the first aspect, the at least one memory and the computer program code are configured to, with the at least one processor, cause the network device at least to cause transmission of the cell operation mode indication in radio resource control signaling.

In an implementation form of the first aspect, the at least one memory and the computer program code are configured to, with the at least one processor, cause the network device at least to cause transmission of a dedicated list of neighbor cells to be measured during the cell operation mode, the dedicated list of neighbor cells excluding neighbor cells being in the cell operation mode.

In an implementation form of the first aspect, the cell operation mode comprises a cell shutdown mode initiating a cell transmission power reduction sequence, or a cell start-up mode initiating a cell transmission power increase sequence.

In an implementation form of the first aspect, the network comprises a non-terrestrial network.

In an implementation form of the first aspect, the network comprises a terrestrial network.

According to a second aspect, a user device may comprise at least one processor and at least one memory including computer program code. The at least one memory and the computer program code are configured to, with the at least one processor, cause the user device at least to receive cell operation mode configuration parameters to be applied in a cell operation mode, receive a cell operation mode indication associated with at least one cell of a network, the cell operation mode initiating a cell transmission power change sequence, and estimate a path loss between the user device and at least one cell at least partly based on the cell operation mode configuration parameters.

In an implementation form of the second aspect, the cell operation mode configuration parameters comprise at least one of a cell transmission power scaling parameter, time duration parameter, or start or end time parameter.

In an implementation form of the second aspect, the start or end time parameter is associated with an absolute subframe number or the default paging cycle, or a synchronization signal and PBCH block periodicity or any other network-controlled period.

In an implementation form of the second aspect, the at least one memory and the computer program code are configured to, with the at least one processor, cause the user device at least to receive the cell operation mode configuration parameters in system information broadcast signaling.

In an implementation form of the second aspect, the at least one memory and the computer program code are configured to, with the at least one processor, cause the user device at least to receive the cell operation mode configuration parameters in radio resource control signaling.

In an implementation form of the second aspect, the at least one memory and the computer program code are configured to, with the at least one processor, cause the user device at least to receive the cell operation mode indication in system information broadcast signaling.

In an implementation form of the second aspect, the at least one memory and the computer program code are configured to, with the at least one processor, cause the user device at least to receive the cell operation mode indication in radio resource control signaling.

In an implementation form of the second aspect, the at least one memory and the computer program code are configured to, with the at least one processor, cause the user device at least to receive a dedicated list of neighbor cells to be measured during the cell operation mode, the dedicated list of neighbor cells excluding neighbor cells being in the cell operation mode, and apply the dedicated list of neighbor cells when measuring neighbor cells.

In an implementation form of the second aspect, the cell transmission power comprises a synchronization signal and PBCH block, SSB, transmission power, and the at least one memory and the computer program code are configured to, with the at least one processor, cause the user device at least to measure a reference signal received power, RSRP, based on the SSB from the cell; estimate a current SSB transmission power scaling step based on the operation mode configuration parameters; estimate a current SSB transmission power level based on an original SSB transmission power level, the current SSB transmission power scaling step and transmission power scaling per step; and estimate the path loss between the user device and the cell based on the current SSB transmission power level.

In an implementation form of the second aspect, the at least one memory and the computer program code are configured to, with the at least one processor, cause the user device at least to receive, from a neighbor cell of the cell in the cell operation mode, the cell operation mode configuration parameters, and utilize the cell operation mode configuration parameters received from the neighbor cell when estimating the path loss.

In an implementation form of the second aspect, the cell operation mode comprises a cell shutdown mode initiating a cell transmission power reduction sequence, or a cell start-up mode initiating a cell transmission power increase sequence.

In an implementation form of the second aspect, the network comprises a non-terrestrial network.

In an implementation form of the second aspect, the network comprises a terrestrial network.

According to a third aspect, a method may comprise transmitting, by a network device, cell operation mode configuration parameters to be applied in a cell operation mode; and transmitting, by the network device, a cell operation mode indication associated with at least one cell of a network, the cell operation mode initiating a cell transmission power change sequence.

In an implementation form of the third aspect, the cell operation mode configuration parameters comprise at least one of a cell transmission power scaling parameter, time duration parameter, or start or end time parameter.

In an implementation form of the third aspect, the start or end time parameter is associated with an absolute subframe number or the default paging cycle, or a synchronization signal and block, SSB, PBCH periodicity or any other network-controlled period.

In an implementation form of the third aspect, the method comprises changing the cell transmission power based on the cell operation mode configuration parameters.

In an implementation form of the first aspect, the method comprises causing transmission of the cell operation mode configuration parameters in system information broadcast signaling.

In an implementation form of the third aspect, the method comprises causing transmission of the cell operation mode configuration parameters in radio resource control signaling.

In an implementation form of the third aspect, the method comprises preventing triggering of a system information change indication when changing a level of the cell transmission power, when the cell operation mode is enabled.

In an implementation form of the third aspect, the method comprises causing transmission of the cell operation mode indication in system information broadcast signaling.

In an implementation form of the third aspect, causing transmission of the cell operation mode indication in system information broadcast signaling.

In an implementation form of the third aspect, causing transmission of a dedicated list of neighbor cells to be measured during the cell operation mode, the dedicated list of neighbor cells excluding neighbor cells being in the cell operation mode.

In an implementation form of the third aspect, the cell operation mode comprises a cell shutdown mode initiating a cell transmission power reduction sequence, or a cell start-up mode initiating a cell transmission power increase sequence.

In an implementation form of the third aspect, the network comprises a non-terrestrial network.

In an implementation form of the third aspect, the network comprises a terrestrial network.

According to a fourth aspect, a method may comprise receiving, by a user device, cell operation mode configuration parameters to be applied in a cell operation mode, receiving, by the user device, a cell operation mode indication associated with at least one cell of a network, the cell operation mode initiating a cell transmission power change sequence, and estimating, by the user device, a path loss between the user device and at least one cell at least partly based on the cell operation mode configuration parameters.

In an implementation form of the fourth aspect, the cell operation mode configuration parameters comprise at least one of a cell transmission power scaling parameter, time duration parameter, or start or end time parameter.

In an implementation form of the fourth aspect, the start or end time parameter is associated with an absolute subframe number or the default paging cycle, or a synchronization signal and PBCH block periodicity or any other network-controlled period.

In an implementation form of the fourth aspect, the method comprises receiving the cell operation mode configuration parameters in system information broadcast signaling.

In an implementation form of the fourth aspect, the method comprises receiving the cell operation mode configuration parameters in radio resource control signaling.

In an implementation form of the fourth aspect, the method comprises receiving the cell operation mode indication in system information broadcast signaling.

In an implementation form of the fourth aspect, the method comprises receiving the cell operation mode indication in system information broadcast signaling.

In an implementation form of the fourth aspect, the method comprises receiving a dedicated list of neighbor cells to be measured during the cell operation mode, the dedicated list of neighbor cells excluding neighbor cells being in the cell operation mode, and applying the dedicated list of neighbor cells when measuring neighbor cells.

In an implementation form of the fourth aspect, the cell transmission power comprises a synchronization signal and PBCH block, SSB, transmission power, and the method comprises measuring a reference signal received power, RSRP, based on the SSB from the cell; estimating a current SSB transmission power scaling step based on the operation mode configuration parameters; estimating a current SSB transmission power level based on an original SSB transmission power level, the current SSB transmission power scaling step and transmission power scaling per step; and estimating the path loss between the user device and the cell based on the current SSB transmission power level.

In an implementation form of the fourth aspect, the cell operation mode comprises a cell shutdown mode initiating a cell transmission power reduction sequence, or a cell start-up mode initiating a cell transmission power increase sequence.

In an implementation form of the fourth aspect, the network comprises a non-terrestrial network.

In an implementation form of the fourth aspect, the network comprises a terrestrial network.

According to a fifth aspect, there is provided a computer program comprising instructions for causing an apparatus to perform at least the following: transmitting cell mode configuration operation parameters to be applied in a cell operation mode; and transmitting a cell operation mode indication associated with at least one cell of a network, the cell operation mode initiating a cell transmission power change sequence.

According to a sixth aspect, there is provided a computer program comprising instructions for causing an apparatus to perform at least the following: receiving cell operation mode configuration parameters to be applied in a cell operation mode, receiving a cell operation mode indication associated with at least one cell of a network, the cell operation mode initiating a cell transmission power change sequence, and estimating a path loss between the user device and at least one cell at least partly based on the cell operation mode configuration parameters.

According to a seventh aspect, a network device may comprise means for: transmitting cell operation mode configuration parameters to be applied in a cell operation mode, and transmitting a cell operation mode indication associated with at least one cell of a network, the cell operation mode initiating a cell transmission power change sequence.

According to an eighth aspect, a user device comprise means for: receiving cell operation mode configuration parameters to be applied in a cell receiving operation mode, a cell operation mode indication associated with at least one cell of a network, the cell operation mode initiating a cell transmission power change sequence, and estimating a path loss between the user device and at least one cell at least partly based on the cell operation mode configuration parameters.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an Earth-fixed cell in a non-terrestrial network according to an example embodiment.

FIG. 2A illustrates an example of a method for a network device of a network according to an example embodiment.

FIG. 2B illustrates an example of a method for a user device of a network according to an example embodiment.

FIG. 3 illustrates a signaling diagram for applying a cell operation mode in a network according to an example embodiment.

FIG. 4 illustrates a signaling diagram for applying a cell operation mode in a network according to an example embodiment.

FIG. 5 illustrates an example of an apparatus configured to practice one or more example embodiments.

FIG. 6 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

In the following, the term “cell operation mode” may refer to a state of an Earth-fixed cell (EFC) provided by a network device. When the cell operation mode is a cell shutdown mode, the EFC is still operational but the network device has initiated a process to turn off the EFC. When the cell operation mode is a cell start-up mode, the EFC has become operational as a new cell.

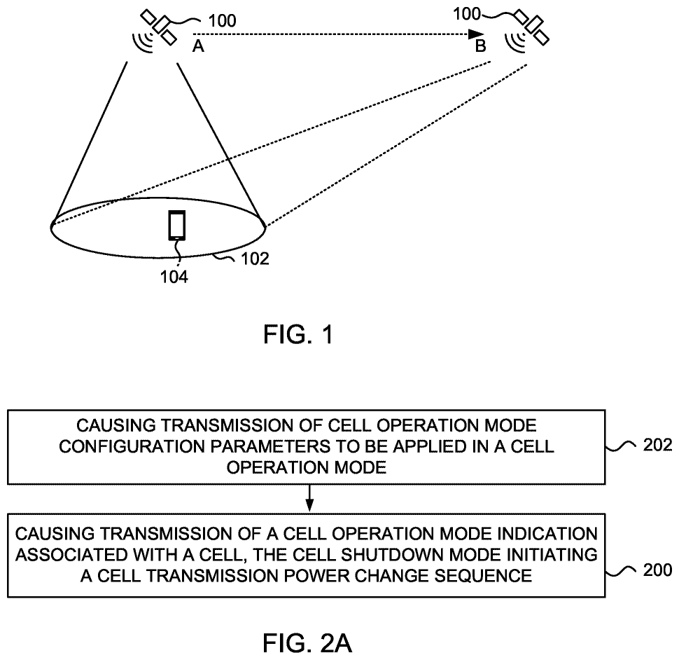

FIG. 1 illustrates an Earth-fixed cell in a non-terrestrial network (NTN) according to an example embodiment. At a first time moment, a satellite 100 providing a cell 102 is at a location A, and a second time moment, the satellite 100 has moved to a location B. As the satellite provides an Earth-fixed cell, the location of the cell 102 remains in place with respect to a user device 104. The cell 102 will eventually be subject to a change of the satellite, because the previous satellite moves too far away from the fixed location of the user device 104 on Earth (location B). Depending on satellite constellation and capability this may happen more or less frequently, but the fast satellite movement (about 7.5 km/s for 600 km altitude) means it is in the order of minutes for typical scenarios.

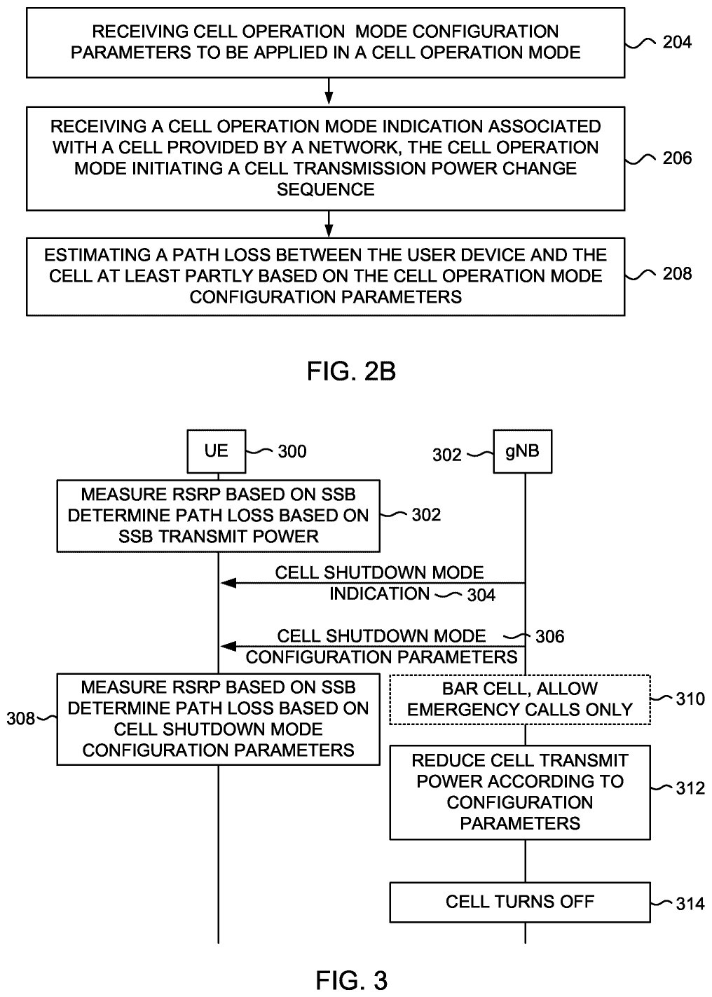

FIG. 2A illustrates an example of a method for a network device of a network according to an example embodiment. The method may be performed by a network device, for example, a base station or a gNB.

At 200 the network device may cause transmission of cell operation mode configuration parameters to be applied in a cell operation mode. The cell operation mode configuration parameters may relate to one or more cells.

At 202 the network device may cause transmission of a cell operation mode indication associated with at least one cell of a network, the cell operation mode initiating a cell transmission power change sequence. Thus, the cell operation mode indication may associated with only one cell of a group of cells. The change may be gradual, continuous or any other change sequence. The cell operation mode indication may provide an indication about the fact that the cell will still exist only a predetermined time. In another example embodiment, the cell operation mode indication may provide an indication that the cell has just started and will be ramping up its transmission power. The cell change mode indication may be included in a dedicated information element, and a change in the information element, for example, from change disabled (off) to enabled (on) triggers a system information (SI) change indication, and due to this, the new mode is then known to any UE of this serving cell (both radio resource control (RRC) Idle/Inactive and Connected UEs). A subsequent change of the SS-PBCH-BlockPower parameter may be excluded or prevented from triggering an SI change indication whenever the cell change mode is enabled. However, the value of this parameter may still updated in the system information (for example, the SIB1) after each power change step so that new UEs in the cell are aware of its current value.

In an example embodiment, before step 202, the network device enable or may determine to enable the cell operation mode for a cell of a non-terrestrial network. The determination may be performed, for example, when the distance of the network device to an Earth-fixed cell reaches a predetermined threshold or when an elevation angle drops under a predetermined threshold.

In an example embodiment, the network may be a non-terrestrial network comprising one or more low-Earth orbit (LEO) satellites. In another example embodiment, the network may be a terrestrial network.

In an example embodiment, the cell operation mode configuration parameters may be transmitted simultaneously with the cell operation mode indication, for example, in a system information broadcast 1 (SIB1). Alternatively, the cell operation mode configuration parameters may be transmitted before transmitting the cell operation mode indication. In an example embodiment, the cell operation mode indication may be transmitted in the SIB1, and the cell operation mode configuration parameters may be transmitted in radio resource control (RRC) signaling, using both the SIB1 and RRC. In another example embodiment, the cell operation mode configuration parameters may be transmitted independently prior to the cell operation mode indication, for example, using dedicated RRC signaling for a UE in the RRC Connected mode. Thus, the cell operation mode configuration parameters are then ready to be applied when transmitting the cell operation mode indication.

In an example embodiment, the cell operation mode configuration parameters may comprise at least one of a cell transmission power scaling parameter, time duration parameter, or start or end time parameter. The cell transmission power scaling parameter may indicate, for example, a power reduction or increase per step (for example, 3 dB reduction per step). The time duration parameter may indicate, for example, the time duration per step (for example, 10 s per step). In an example embodiment, the cell transmission power scaling parameter and the time duration parameter may be combined to a gradient. Based on the start or end time parameter, an UE knows when each step takes place. This may be linked to an absolute subframe number (SFN) and or default paging cycle, or the synchronization signal and PBCH block, SSB, periodicity or any other network-controlled period. In an example embodiment, as the end time at which a cell stops covering the current area is known in NTN for an earth fixed cell, the information may also define that the cell power scaling starts x seconds before such end time. The current step may also be indicated, i.e. cell is at ramping step x out of y.

Regarding the use of the gradient, there may be needed an implementation/standardized approach by the UE to determine the actual transmit power, being a function of the “absolute transmit power starting point+gradient*time” and most likely an integer value. For example, the estimated value could be floored to nearest integer.

In an example embodiment, the network device may transmit a dedicated list of neighbor cells to be measured during the cell shutdown mode, the dedicated list of neighbor cells excluding neighbor cells being in the cell shutdown mode. Thus, the list of the neighbor cells to be measured by the UE may be optimized by taking into account the shutdown mode of these cells during the transient.

In an example embodiment, the network device may bar new UEs from connecting (with the exception of emergency calls) to a cell that is turning off.

FIG. 2B illustrates an example of a method for a user device of a network according to an example embodiment. The method may be performed by a user device, for example, a user equipment or an IoT device.

At 204 the user device may receive cell operation mode configuration parameters to be applied in a cell operation mode. The cell operation mode configuration parameters may relate to an existing cell to which the user device is already connected to. Alternatively or additionally, the cell operation mode configuration parameters may relate to one or more cells with which the user device is not yet connected.

At 206 the user device may receive a cell operation mode indication associated with at least one cell of a network, the cell operation mode initiating a cell transmission power change sequence.

At 208 the user device may estimate a path loss between the user device and at least one cell at least partly based on the cell operation mode configuration parameters. The estimated path loss may be used, for example, for open loop power control, while the measurement itself (the RSRP) may not be based on the configuration parameters.

In an example embodiment, the user device may be connected to a first cell. The received cell operation mode configuration parameters may relate to at least one other cell, and the user device may use the received cell operation mode configuration parameters when measuring one or more of the at least one other cell.

In an example embodiment, the network may be a non-terrestrial network comprising one or more low-Earth orbit (LEO) satellites. In another example embodiment, the network may be a terrestrial network.

In an example embodiment, the cell operation mode configuration parameters may be received simultaneously with the cell operation mode indication, for example, in a system information broadcast 1 (SIB1). Alternatively, the cell operation mode configuration parameters may be transmitted before transmitting the cell operation mode indication. In an example embodiment, the cell operation mode indication may be received in the SIB1, and the cell operation mode configuration parameters may be received in radio resource control (RRC) signaling, using both SIB1 the and RRC. In another example embodiment, the cell operation mode configuration parameters may be received independently prior to the cell operation mode indication. Thus, the cell operation mode configuration parameters are then ready to be applied when receiving the cell operation mode indication. In an example embodiment, a network may use the same configuration parameters by default, for example, 3 dB steps every 200 ms for 1 second, for all cells. This can be informed to a UE the first time it connects (by RRC signaling) or alternatively can be preprogrammed in the UE.

In an example embodiment, the cell operation mode configuration parameters may comprise at least one of a cell transmission power scaling parameter, time duration parameter, or start or end time parameter. The cell transmission power scaling parameter may indicate, for example, a power reduction or increase per step (for example, 3 dB reduction per step). The time duration parameter may indicate, for example, the time duration per step (for example, 10 s per step). In an example embodiment, the cell transmission power scaling parameter and the time duration parameter may be combined to a gradient. Based on the start or end time parameter, an UE knows when each step takes place. This may be linked to an absolute subframe number (SFN) or the default paging cycle, or the SSB periodicity or any other network-controlled period. In an example embodiment, as the end time at which a cell stops covering the current area is known in NTN for an earth fixed cell, the information may also define that the cell power scaling starts x seconds before such end time. The current step may also be indicated, i.e. cell is at ramping step X out of y.

In an example embodiment, the user device may receive a dedicated list of neighbor cells to be measured during the cell shutdown mode, the dedicated list of neighbor cells excluding neighbor cells being in the cell shutdown mode, and apply the dedicated list of neighbor cells when measuring neighbor cells. Thus, the list of the neighbor cells to be measured by the UE may be optimized by taking into account the shutdown mode of these cells during the transient.

In an example embodiment, the cell transmission power may comprise a synchronization signal and PBCH block, SSB, transmission power, and the user device may measure a reference signal received power, RSRP, based on the SSB from the cell, estimate a current SSB transmission power scaling step based on the operation mode configuration parameters, estimate a current SSB transmission power level based on an original SSB transmission power level, the current SSB transmission power scaling step and transmission power scaling per step and estimate the path loss between the user device and the cell based on the current SSB transmission power level.

In an example embodiment, legacy UEs may not be able to interpret the information on a cell being in a cell operation mode. Since the update of the SS-PBCH-BlockPower parameter may be exempted from triggering an SI change indication, the legacy UEs will not be aware that the cell's transmit power is changed. This may mean a legacy UE will estimate that the pathloss has dropped x dB, where x is the amount of power the SS-PBCH-BlockPower parameter is changed. A legacy UE using open loop transmit power control will therefore compensate for the additional (estimated) path loss according to the compensation factor alpha. Depending on the alpha value, which is in the range [0 0.4:0.1:1], this could lead to the UE transmitting with maximum power. Therefore, in one embodiment, the gNB may adjust the transmit power control parameters. In case of open loop power control this would require a change of alpha, while for closed loop power control, the TPC command f (for example, provided in downlink control information (DCI)) could be adjusted.

In an example embodiment, the user device may be configured to receive, from a neighbor cell of the cell in the cell operation mode, the cell operation mode configuration parameters, and utilize the cell operation mode configuration parameters received from the neighbor cell when estimating the path loss. The cell operation mode configuration parameters received from the neighbor cell can help the user device measuring the cell in the cell shutdown/start-up mode to understand what is happening with the transmit power of the network device without getting the configuration parameters only directly from the cell being in the cell shutdown/start-up mode.

FIG. 3 illustrates a signaling diagram for applying a cell shutdown mode in a network according to an example embodiment. The network may be a non-terrestrial network or a terrestrial network.

Before receiving a cell shutdown mode indication 304 from a base station, for example, a gNB 302, a UE 300 may measure a reference signal received power, RSRP, based on the synchronization signal and PBCH block, SSB, and determine a path loss based on the SSB transmit power. After receiving the cell shutdown mode indication 304 and cell shutdown mode configuration parameters 306 from the gNB 302, the UE 300 acts differently than at 302. At 308 while still measuring the RSRP based on the SSB, the path loss is now determined by the UE 300 based on the cell shutdown mode configuration parameters.

At 310, the gNB 302 may be configured to bar the cell from new UEs and allow emergency calls only.

At 312 the gNB 302 is configured to change the cell transmit power according to the cell shutdown mode configuration parameters. When changing the cell transmit power, the gNB 302 may be configured to update SIB1 information without triggering an SI change indication.

Eventually, after some time has passed, at 314 the cell turns off according to the cell shutdown mode configuration parameters. During the time between steps 308 and 314, the UE 300 is able to perform handover/cell reselection before the cell is turned off.

Even if FIG. 3 illustrates an example applying the cell shutdown mode, the illustrated operations may be applied also in the cell start-up mode when the cell become operational as a new cell. In this case, steps 310 and 314 can be omitted.

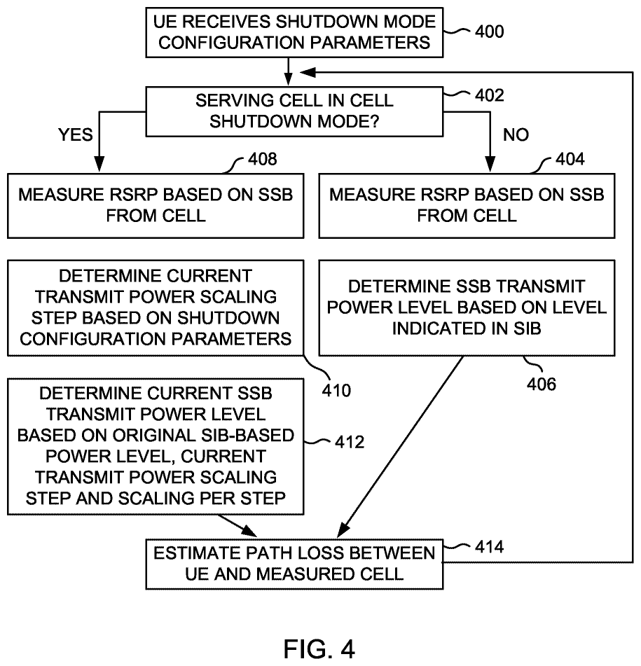

FIG. 4 illustrates a signaling diagram for applying a cell shutdown mode in a network according to an example embodiment. The signaling diagram illustrates the process by using UE perspective. The network may be a non-terrestrial network or a terrestrial network.

At 400 a UE receives shutdown mode configuration parameters from a gNB. At 402 the UE determines whether a serving cell is in a cell shutdown mode. As discussed, for example, in connection with FIG. 3, the UE may receive from the gNB a cell shutdown mode indication. This provides an indication to the UE that the serving cell has entered a mode that will eventually lead to turning off the serving cell.

When the UE determines at 402 that the serving cell is not in the cell shutdown mode, the UE may measure the RSRP based on the SSB, and determines the SSB transmit power level based on the level indicated in the SIB. Then, at 414 the UE may estimate a path loss between the US and the measured cell.

When the UE determines at 402 that the serving cell is in the cell shutdown mode, the UE first measures at 408 the RSRP based on the SSB. Then, at 410 the UE may determine a current SSB transmit power scaling step based on the cell shutdown mode configuration parameters. Then, at 412 the UE may determine a current SSB transmit power level based on an original SSB transmission power level, the current SSB transmit power scaling step and transmission power scaling per step. Then, at 414 the UE may estimate a path loss between the US and the measured cell based on the current SSB transmit power level.

Even if FIG. 4 illustrates an example applying the cell shutdown mode, the illustrated operations may be applied also in the cell start-up mode when the cell become operational as a new cell.

One or more of the above discussed examples and embodiments may enable a faster shutdown of the serving cell, because the network does not need to follow the timing for the power level change according to the SI modification procedure. This may be useful for an NTN, where an overlap time of two cells shall be reduced to minimize interference and reduce risk of lost measurement reports. One or more of the above discussed examples and embodiments may remove the need for SI update at every power change step (when decreasing the value of the SS-PBCH-BlockPower parameter). One or more of the above discussed examples and embodiments may allow the UE to refine the RSRP/RSRQ measurements of neighbor cells for a handover and cell reselection by excluding the cells that are being turned off. One or more of the above discussed examples and embodiments may enable a solution that may be applied in a non-terrestrial network or a terrestrial network. This may enable a faster cell shutdown thus enabling network energy saving. One or more of the above discussed examples and embodiments, when applying the cell start-up mode, may be useful for a UE performing measurements on a target cell to know that the target cell is ramping up its transmission power. Then the UE can estimate that in x seconds the power will be y dB higher and thus the cell is a good candidate (exceeding some mobility criteria) for mobility. This may become obvious through normal measurements, but the UE may makes one measurement and determine that a cell is not good enough and stops the further measurements. However, when applying the start-up mode, the UE is able to know that the cell will actually be good enough in a short while.

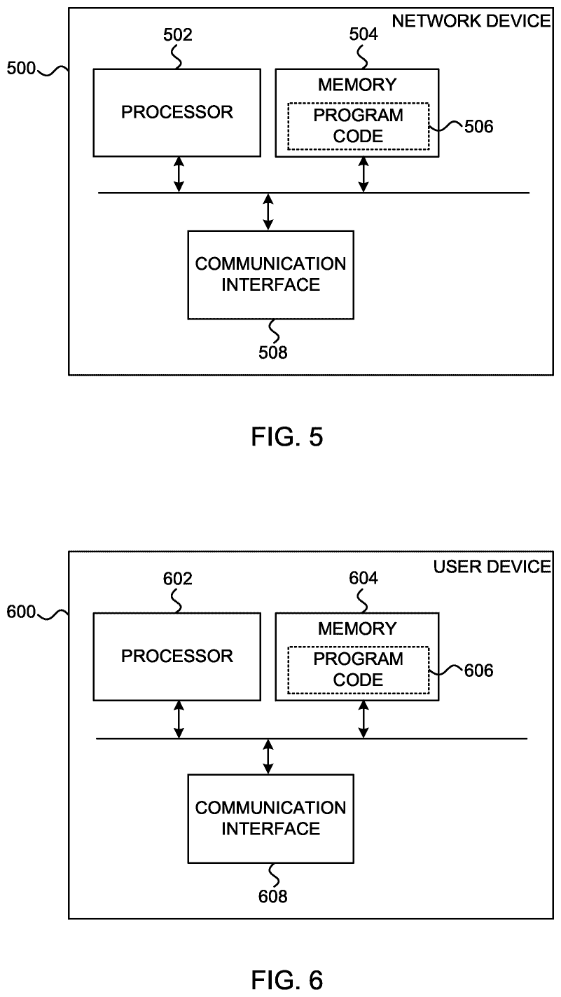

FIG. 5 illustrates an example of an apparatus 500 configured to practice one or more example embodiments. The apparatus 500 may comprise at least one processor 502. The at least one processor 502 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 500 may further comprise at least one memory 504. The at least one memory 504 may be configured to store, for example, computer program code or the like, for example, operating system software and application software. The at least one memory 504 may comprise one or more volatile memory devices, one or more non-volatile example, the at least one memory 504 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 500 may further comprise a communication interface 508 configured to enable apparatus 500 to transmit and/or receive information to/from other devices. In one example, the apparatus 500 may use the communication interface 508 to transmit or receive signaling information and data in accordance with at least one data communication or cellular communication protocol. The communication interface 508 may be configured to provide at least one wireless radio connection, such as, for example, a 3GPP mobile broadband connection (e.g. 3G, 4G, 5G, 6G etc.). The communication interface 508 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 500 is configured to implement some functionality, some component and/or components of the apparatus 500, for example, the at least one processor 502 and/or the at least one memory 504, may be configured to implement this functionality. Furthermore, when the at least one processor 502 is configured to implement some functionality, this functionality may be implemented using the program code 506 comprised, for example, in the at least one memory 504.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), application-specific Integrated Circuits (ASICS), application-specific Standard Products (ASSPs), System-on-a-chip systems (SOCs), Complex Programmable Logic Devices (CPLDs), and Graphics Processing Units (GPUS).

The apparatus 500 may comprise means for performing at least one method described herein. In an example embodiment, the means may comprise the at least one processor 502, the at least one memory 504 including program code 506 configured to, when executed by the at least one processor, cause the apparatus 500 to perform the method.

The apparatus 500 may comprise, for example, a computing device, for example, a base station, a server, a network node, a cloud node or the like. Although the apparatus 500 is illustrated as a single device it is appreciated that, wherever applicable, functions of the apparatus 500 may be distributed to a plurality of devices, for example, to implement example embodiments as a cloud computing service.

An apparatus, for example, a device such as a base station or a network device, may be configured to perform or cause performance of any aspect of the method(s) described herein. Further, a computer program may comprise instructions for causing, when executed, an apparatus perform any aspect of the method(s) described herein. The computer program may be stored on a computer-readable medium. Further, the apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

FIG. 6 illustrates an example of an apparatus 600 configured to practice one or more example embodiments. The apparatus 600 may comprise at least one processor 602. The at least one processor 602 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 600 may further comprise at least one memory 604. The at least one memory 604 may be configured to store, for example, computer program code or the like, for example, operating system software and application software. The at least one memory 604 may comprise one or more volatile memory devices, one or more non-volatile example, the at least one memory 604 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 600 may further comprise a communication interface 608 configured to enable apparatus 600 to transmit and/or receive information to/from other devices. In one example, the apparatus 600 may use the communication interface 608 to transmit or receive signaling information and data in accordance with at least one data communication or cellular communication protocol. The communication interface 608 may be configured to provide at least one wireless radio connection, such as, for example, a 3GPP mobile broadband connection (e.g. 3G, 4G, 5G, 6G etc.). In another example embodiment, the communication interface 608 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 608 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 600 is configured to implement some functionality, some component and/or components of the apparatus 600, for example, the at least one processor 602 and/or the at least one memory 604, may be configured to implement this functionality. Furthermore, when the at least one processor 602 is configured to implement some functionality, this functionality may be implemented using the program code 606 comprised, for example, in the at least one memory 604.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), application-specific Integrated Circuits (ASICs), application-specific Standard Products (ASSPs), System-on-a-chip systems (SOCs), Complex Programmable Logic Devices (CPLDs), and Graphics Processing Units (GPUS).

The apparatus 600 may comprise means for performing at least one method described herein. In an example embodiment, the means may comprise the at least one processor 602, the at least one memory 604 including program code 606 configured to, when executed by the at least one processor, cause the apparatus 600 to perform the method.

The apparatus 600 may comprise, for example, a computing device, for example, a mobile device, a mobile phone, a user device, a user equipment, a user node, a tablet computer, a laptop, an internet of things (IoT) device, a tag, or the like. Examples of IoT devices include, but are not limited to, consumer electronics, wearables, sensors, and smart home appliances. Although the apparatus 600 is illustrated as a single device it is appreciated that, wherever applicable, functions of the apparatus 600 may be distributed to a plurality of devices, for example, to implement example embodiments as a cloud computing service.

An apparatus, for example, a device such as a mobile device, a mobile phone, a user device, a user equipment, a user node, a tablet computer, a laptop, an internet of things (IoT) device, or a tag, may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, the apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its for their) software and/or accompanying firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1.-24. (canceled)

25. A user device comprising:
at least one processor; and
at least one memory including computer program code, the at least one memory and the computer program code configured to, with the at least one processor, cause the user device at least to:
receive cell operation mode configuration parameters to be applied in a cell operation mode, wherein the cell operation mode configuration parameters comprise a cell transmission power scaling parameter for a cell transmission power, a time duration parameter, and start and end time parameter, wherein the cell transmission power comprises a synchronization signal and physical broadcast channel block (SSB) transmission power, and wherein the cell operation mode comprises a cell shutdown mode initiating a cell transmission power reduction sequence;
receive a cell operation mode indication associated with a first cell of a network, the cell operation mode initiating a cell transmission power change sequence for the first cell;
receive a dedicated list of neighbor cells to be measured during the cell operation mode, the dedicated list of neighbor cells excluding the first cell and other neighbor cells being in the cell operation mode;
for each cell in the dedicated list of neighbor cells that not in the cell operation mode:
measure a reference signal received power (RSRP) based on the SSB from the cell;
determine a power level at which the SSB is being transmitted, using information from a System Information Block (SIB); and
estimate a path loss between the user device and the cell based on the information from the SIB; and
for the first cell in the cell operation mode and without System Information (SI) updates:
measure a first RSRP based on a first SSB from the first cell;
determine a current SSB transmit power scaling step based on cell operation mode configuration parameters for the cell shutdown mode;
determine a current SSB transmission power level based on an original SSB transmission power level, a current SSB transmission power scaling step;
estimate the path loss between the user device and the cell based on the current SSB transmission power level; and
based on the estimated path loss, execute a handover.

26. The user device of claim 25, wherein a triggering of an SI change indication is prevented when changing a level of a transmission power of the first cell, when the cell operation mode is enabled.

27. The user device of claim 26, wherein the start and end time parameter is associated with an absolute subframe number or a default paging cycle, or a SSB periodicity.

28. The user device of claim 27, wherein the at least one memory including computer program code, the at least one memory and the computer program code are configured to, with the at least one processor, cause the user device at least to:
receive the cell operation mode configuration parameters in the following: system information broadcast signaling and radio resource control signaling.

29. The user device of claim 28, wherein the at least one memory including computer program code, the at least one memory and the computer program code are configured to, with the at least one processor, cause the user device at least to:
receive the cell operation mode indication in the following: system information broadcast signaling, and radio resource control signaling.

30. The user device of claim 29, wherein the at least one memory including computer program code, the at least one memory and the computer program code are configured to, with the at least one processor, cause the user device at least to:
receive, from a neighbor cell of the cell in the cell operation mode, the cell operation mode configuration parameters; and
utilize the cell operation mode configuration parameters received from the neighbor cell when estimating the path loss.

31. The user device of claim 30, wherein the cell operation mode further comprises a cell start-up mode initiating a cell transmission power increase sequence.

32. The user device of claim 31, wherein the network comprises a non-terrestrial network or a terrestrial network.

33. A system comprising:
a user device comprising:
at least one processor; and
at least one memory including computer program code, the at least one memory and the computer program code configured to, with the at least one processor, cause the user device at least to:
receive cell operation mode configuration parameters to be applied in a cell operation mode, wherein the cell operation mode configuration parameters comprise a cell transmission power scaling parameter for a cell transmission power, a time duration parameter, and start and end time parameter, wherein the cell transmission power comprises a synchronization signal and physical broadcast channel block (SSB) transmission power, and wherein the cell operation mode comprises a cell shutdown mode initiating a cell transmission power reduction sequence;
receive a cell operation mode indication associated with a first cell of a network, the cell operation mode initiating a cell transmission power change sequence for the first cell;
receive a dedicated list of neighbor cells to be measured during the cell operation mode, the dedicated list of neighbor cells excluding the first cell and other neighbor cells being in the cell operation mode;
for each cell in the dedicated list of neighbor cells that not in the cell operation mode:
measure a reference signal received power (RSRP) based on the SSB from the cell;
determine a power level at which the SSB is being transmitted, using information from a System Information Block (SIB); and
estimate a path loss between the user device and the cell based on the information from the SIB; and
for the first cell in the cell operation mode and without System Information (SI) updates:
measure a first RSRP based on a first SSB from the first cell;
determine a current SSB transmit power scaling step based on cell operation mode configuration parameters for the cell shutdown mode;
determine a current SSB transmission power level based on an original SSB transmission power level, a current SSB transmission power scaling step;
estimate the path loss between the user device and the cell based on the current SSB transmission power level; and
based on the estimated path loss, execute a handover.

34. The system of claim 33, wherein a triggering of an SI change indication is prevented when changing a level of a transmission power of the first cell, when the cell operation mode is enabled.

35. The system of claim 34, wherein the start and end time parameter is associated with an absolute subframe number or a default paging cycle, or a SSB periodicity.

36. The system of claim 35, wherein the at least one memory including computer program code, the at least one memory and the computer program code are configured to, with the at least one processor, cause the user device at least to:
receive the cell operation mode configuration parameters in the following: system information broadcast signaling and radio resource control signaling.

37. The system of claim 36, wherein the at least one memory including computer program code, the at least one memory and the computer program code are configured to, with the at least one processor, cause the user device at least to:
receive the cell operation mode indication in the following: system information broadcast signaling, and radio resource control signaling.

38. The system of claim 37, wherein the at least one memory including computer program code, the at least one memory and the computer program code are configured to, with the at least one processor, cause the user device at least to:
receive, from a neighbor cell of the cell in the cell operation mode, the cell operation mode configuration parameters; and
utilize the cell operation mode configuration parameters received from the neighbor cell when estimating the path loss.

39. The system of claim 38, wherein the cell operation mode further comprises a cell start-up mode initiating a cell transmission power increase sequence.

40. The system of claim 39, wherein the network comprises a non-terrestrial network or a terrestrial network.

41. A method comprising:
receiving, from a user device, cell operation mode configuration parameters to be applied in a cell operation mode, wherein the cell operation mode configuration parameters comprise a cell transmission power scaling parameter for a cell transmission power, a time duration parameter, and start and end time parameter, wherein the cell transmission power comprises a synchronization signal and physical broadcast channel block (SSB) transmission power, and wherein the cell operation mode comprises a cell shutdown mode initiating a cell transmission power reduction sequence;
receiving a cell operation mode indication associated with a first cell of a network, the cell operation mode initiating a cell transmission power change sequence for the first cell;
receiving a dedicated list of neighbor cells to be measured during the cell operation mode, the dedicated list of neighbor cells excluding the first cell and other neighbor cells being in the cell operation mode;
for each cell in the dedicated list of neighbor cells that not in the cell operation mode:
measure a reference signal received power (RSRP) based on the SSB from the cell;
determine a power level at which the SSB is being transmitted, using information from a System Information Block (SIB); and
estimate a path loss between the user device and the cell based on the information from the SIB; and
for the first cell in the cell operation mode and without System Information (SI) updates:
measure a first RSRP based on a first SSB from the first cell;
determine a current SSB transmit power scaling step based on cell operation mode configuration parameters for the cell shutdown mode;
determine a current SSB transmission power level based on an original SSB transmission power level, a current SSB transmission power scaling step;
estimate the path loss between the user device and the cell based on the current SSB transmission power level; and
based on the estimated path loss, execute a handover.

42. The method of claim 41, wherein a triggering of an SI change indication is prevented when changing a level of a transmission power of the first cell, when the cell operation mode is enabled.

43. The method of claim 42, wherein the start and end time parameter is associated with an absolute subframe number or a default paging cycle, or a SSB periodicity.

44. The method of claim 43, further comprising:
receiving the cell operation mode configuration parameters in the following: system information broadcast signaling and radio resource control signaling;
receiving the cell operation mode indication in the following: system information broadcast signaling, and radio resource control signaling;
receiving, from a neighbor cell of the cell in the cell operation mode, the cell operation mode configuration parameters; and
utilizing the cell operation mode configuration parameters received from the neighbor cell when estimating the path loss.
